(19) United States
(12) Patent Application Publication
(10) Pub. No.: US 2005/0052869 A1
(43) Pub. Date: Mar. 10, 2005

(54) Anti-collision light for aircraft

(76) Inventors: Paul E. Brenner, Kastanienbaum (CH); Thomas C. Brenner, Zurich (CH); Arthur E. Muller, Arni (CH); Thomas Schedler, Schleinikon (CH)

Correspondence Address: Donald S Dowden;Cooper & Dunham, 1185 Avenue of the Americas, New York, NY, 10036, US

(21) Appl. No.: 10/481,049

(22) PCT Filed: Jun. 14, 2002
(86) PCT No.: PCT/IB02/02221

(30) Foreign Application Priority Data
Jun. 15, 2001 (EP) 01114424.3

(51) Int. Cl. F21V 9/00

(52) U.S. Cl. 362/293; 362/298

(57) ABSTRACT

Anticollision-lamp operable in day-light and at night. It is known to provide separate day-light lamps with a high light output, and night-lamps with little infrared radiation in order not to dazzle night vision goggles. The anticollision light according to the invention comprizes at least one optical interference filter (11) with an average transmission factor in the infrared which is less than 4% of its value in the visible white or red. Preferred embodiments comprize among others: an average transmission factor in a spectral domain larger than 80%, preferably 90% and most desirably 95%; the combination of an interference filter (11) with an absorption filter (10) transparent for red light; an interference filter (11) consisting of several plane elements arranged octagonally; and a band-pass interference filter with a transmission domain situated in the visible red and the transmission factor of which is at least 10⁴ times larger than in an infrared domain.

### RELATED APPLICATIONS

This application claims the priority of the European patent application no. 01 114 424.3, filed on the 15^{th} of Jun. 2001, the whole content of which is hereby included by reference.

### TECHNICAL FIELD

The invention relates to an anticollision light for aircrafts.

### STATE OF THE ART

The international regulations for airborne aircrafts (e.g. “JAR”=Joint Aviation Regulations, “FAR”=Federal Aviation Regulations) with fixed wings or rotary wings require an external lighting which in addition to the position lights requires so called anticollision lights which must radiate by day and by night above a certain minimal intensity indicated in Candela. According to JAR 23/25/27/29 the anticollision lights must e.g. radiate in red (“aviation red”) or in white (“aviation white”) with a predetermined intensity and colour, and also within a given solid angle.

An usual source for flashing anticollision lights is e.g. provided by Xenon flashing tubes which emit a light spectrum that appears white to the human eye, and which is provided with a red filter (typically a red glass) for operation in the red spectral region.

This leads to the following problem due to the ever increasing use of night vision goggles (so called NVG), in particular by military aircrafts. The anticollision light (ACL) of anticollison lamps according to JAR/FAR 23/25 and 27/29 also generates an infrared radiation which overloads night vision goggles of all types and therefore dazzles their users. If one wishes to make an aircraft operational both under JAR/FAR regulations and NVG regulations then it is necessary to provide on aircrafts which are equipped for NVG operations, in addition to other light sources, anticollision lights which satisfy the NVG specifications (e.g. according to MIL-L-85762A). This is achieved either through appropriate modifications, or the lighting system must be provided with additional so-called NVG-lights which are NVG compatible. The anticollison light which is in use day and night is a strong lamp the intensive infrared radiation of which raises no problems because no night vision goggles are used during daylight; contraryvise the NVG lamp either radiates with a lesser intensity and/or it carries an optically quite dense coloured filter which also strongly reduces the radiation in the infrared domain. In this way the disturbance of night vision goggles could until now be lessened or avoided whilst at the same time the sensitivity of the human eye, which is much higher in darkness, enabled the radiation which this system admits in the visible spectral domain to be fully sufficient for avoiding collisions. However, this solution has drawbacks, such as the high costs of the necessary modification, the requirement for expensive additional components, and also the additional weight.

### DESCRIPTION OF THE INVENTION

In order to avoid these drawbacks the invention is defined as recited in the main claim.

The solution according to the invention consists in an anticollision lamp for aircrafts which comprises at least one optical filter, the average optical transmission factor of which in a first spectral domain is smaller than 4% of its value in a second spectral domain, where the first domain lies on the longwave side and the second domain lies on the shortwave side of a transition interval situated between the visible red and a boundary located in the infrared region. The low transmission in the infrared makes a disturbance of night vision goggles impossible. At the same time the high transmission in the white or red spectral domain allow it, to satisfy the requirements for a minimal visible light intensity in day-light and for a maximal allowable infrared light intensity at night with one and the same anticollision lamp, and it allows in particular to operate the lamp at the same power. The dependent claims describe preferred embodiments of the invention.

### BRIEF DESCRIPTION OF THE DRAWINGS

Further implementations, advantages and applications of the invention can be derived from the dependent claims and from the following description made with the help of the drawings. Therein,

FIG. 1 shows a simplified perspective view of an embodiment of the invention;

FIG. 2 shows a schematic axial section through the embodiment of FIG. 1;

FIG. 3 shows a very schematic section along III-III of FIG. 2;

FIG. 4 shows an instance of a transmission diagram of the infrared filter of the embodiment according to FIG. 1; and

FIG. 5 shows an example of further a preferred transmission diagram of the infrared filter.

### PREFERRED EMBODIMENT OF THE INVENTION

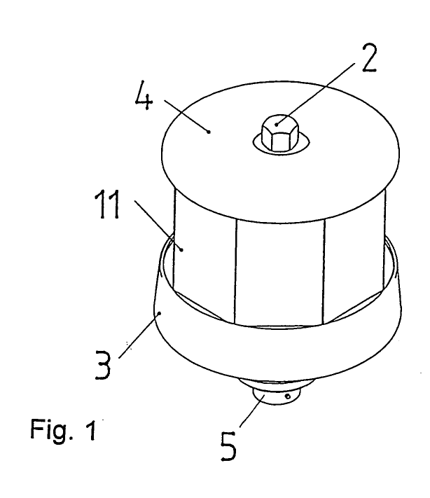

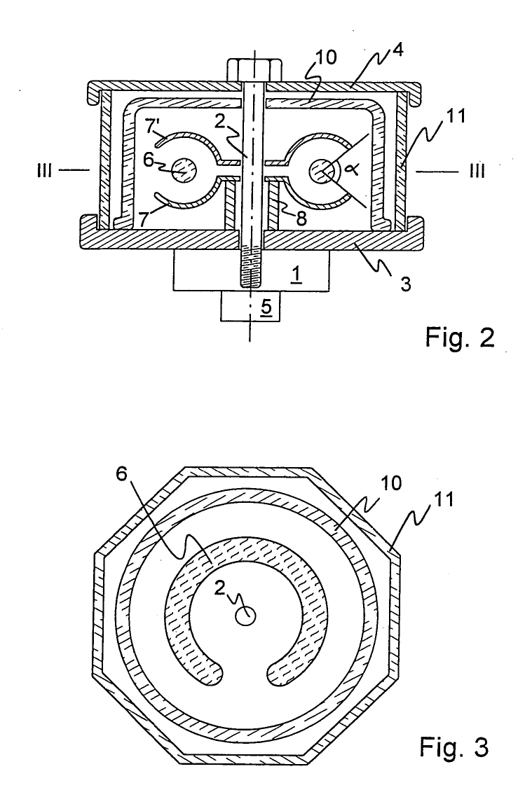

FIG. 2 shows a much simplified a vertical axial section through the embodiment of the invention shown in perspective view in FIG. 1. The lamp is attached through a bolt 2 on a base 1 and it comprises a base plate 3 and a cover plate 4; a Xenon flashing tube 6 of a readily available type is fixed between both plates. In order to obtain an essentially circular emission in all directions, the Xenon flashing tube 6 can e.g. essentially have the shape of a ring or a torus. The base of the tube, which lies outside the plane of the drawing and which deviates from the torus-like shape, is mechanically attached in the usual way (not shown) within the housing of the lamp, and it is electrically connected to electrical conductors (also not shown) which lead to a socket 5 attached on the base 1. The socket comprises contacts for the current needed by the Xenon tube 6 and also for igniting the flashes in the tube. The socket is physically shaped so as to fit into a corresponding fitting provided on the outside of the aircraft, so that it can be connected in the usual way to this fitting. A two-part reflector 7, 7′ surrounds the torus-shaped part of the Xenon cube 6 and is itself essentially shaped like a torus split along its outer periphery. The cups of the reflector extend at least across about 200°, and preferably across 360°, a place for the socket of the Xenon tube 6 being provided in one cup 7. Preferably, the cups 7, 7′ of the reflector are shaped so as to optimally direct the radiation issued from the tube 6 into the desired solid angle and also distribute the radiation throughout this angle. To obtain this the section of the cups can be an arc of circle as shown in FIG. 2, but if the distribution of the light requires it, they can also be shaped differently, e.g. as parts of conic sections. In order to obtain a good efficiency within the desired solid angle the vertical aperture α seen in the section will be less than 180°, preferably less than 130° and most desirably smaller than 90°. The reflector cups 7, 7′ are fixed within the lamp casing in any mechanically appropriate way, e.g. with the help of shims surrounding the bolt 2, of which only shim 8 is sketched in the drawing, and through adequate threads (also not shown) which are arranged so that the upper reflector cup 7′ can easily be removed when it becomes necessary to replace a spent tube 6.

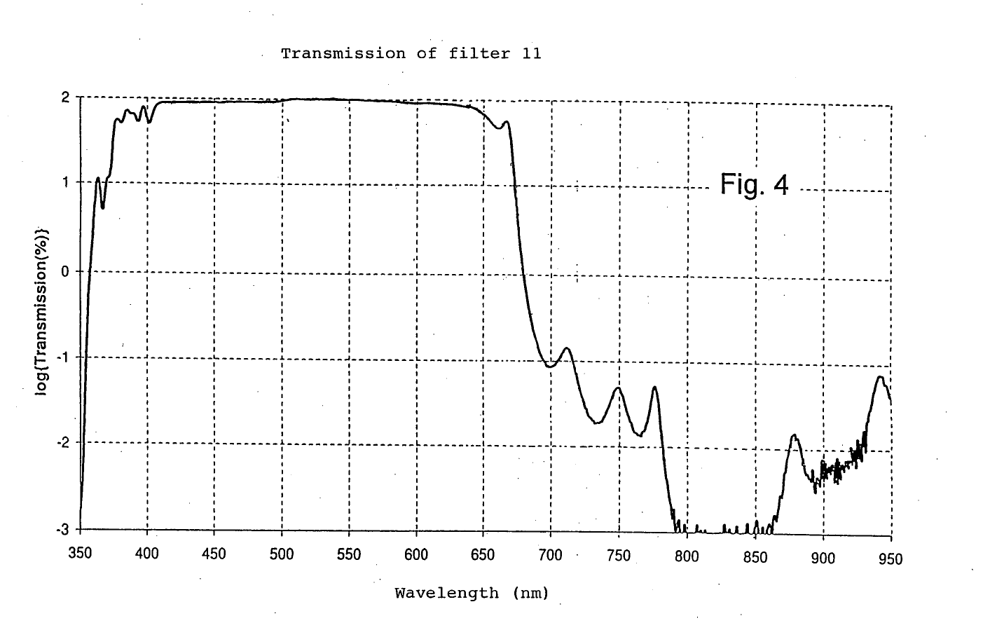

A cup-shaped glass filter 10 encloses the reflector 7, 7′ in order to filter out the wave lengths below the visible red, which aims at making the light look red; the action of this filter on wave lengths in the infrared domain, i.e. above about 680 nm, is irrelevant, however. There is no filter 10 for a white anticollision lamp. The filter 10 is surrounded by a further filter 11 which filters out wave lengths above the visible red domain, so as not to disturb night vision goggles. In the present example the filter 11 comprises 8 octogonally arranged glass panes 11, as best shown in FIG. 1. The panes 11 form a filter 11, e.g. by way of layers which are vaporised in a known fashion on its inner, protected surface; this provides an interference filter which to a large extent removes radiations in the infrared domain, i.e. from about 680 nm up to at least 850 nm, and preferably up to 1000 nm, e.g. as shown by the diagram of FIG. 4. This avoids a disturbance or the overload of night vision goggles which work in the infrared, independently of the effect, and in particular the transmission, of the inner filter 10 in the infrared domain, and also independently of the intensity of the tube 6.

Further embodiments are defined in the dependent claims, such as: an average transmission factor in the first spectral domain which is smaller than 1%, preferably smaller than 0.4%, and most desirably smaller than 0.1% of its value in the second spectral domain; an average transmission factor in the second spectral domain which is larger than 80%, preferably larger as 90%, and most desirably larger than 95%; a first spectral domain which extends into the infrared as far as 850 nm, and preferably at least as far as 1000 nm; a second spectral domain which extends at least across a spectral domain which appears white, in particular across at least the entire visible spectrum (white anticollision lamp) or at least over a visible red spectral domain (red anticollision lamp); a boundary between the first and the second spectral domain which lies between 640 nm and 700 nm, and preferably between 660 nm and 680 nm.

FIG. 3 shows a very schematic section along a line III-III of FIG. 2, in order to clearly illustrate the relative positions of filter 10 and 11, and of the active part of the Xenon tube 6 which has the shape of an incomplete torus. The segmentation of the interference filter 11 into eight plane elements is a practical measure taking into account the fact that there are certain difficulties in vaporising interference layers onto a curved surface. If these difficulties are irrelevant, the filter 11 can equally well consist of one or several cylindrically curved surfaces. The octagonal disposition of the flat interference surfaces 11 of the filter, or alternatively a curvature of the filter surface 11, serve to realize an anticollision lamp able to radiate over a large angular domain, and preferably essentially in all direction, i.e. across about 360°.

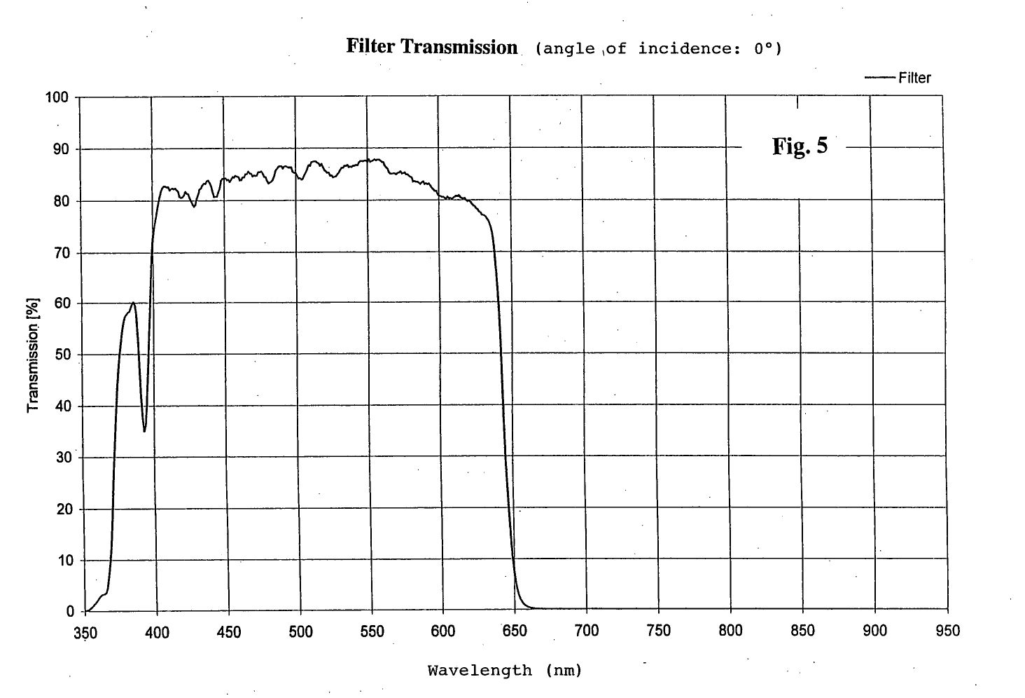

The filter 11 will preferably have a transmission curve which is identical or similar to that shown in FIG. 5, i.e. which has an essentially vanishing transmission factor above a boundary that lies in the interval between 600 nm and 700 nm. For a light falling orthogonally on the filter this transmission factor will preferably be below 2⁻⁷, and it diminishes at least by a factor 10⁴ between 600 nm and 700 nm. This and the arrangement of the filter outside of filter 10 which is essentially transparent in the red domain, makes it possible to avoid with little expenditure the dazzling or overload of night vision goggles, even when using strong light sources. This preferred filter characteristic thus has a high transmission rate in the desired domain, and a steep flank. The value for the NVIS radiance is very small and is preferably NRb <2⁻⁷ at 0.1 fL.

This anticollision lamp can be used for aircrafts of all types but is mainly intended for helicopters and airplanes.

1. Anticollision light for aircrafts characterized in that it comprises at least one optical filter (11) the average optical transmission factor of which in a first spectral domain is below 4% of its value in a second spectral domain, where the first domain lies on the longwave side and the second domain lies on the shortwave side of a transition interval situated between the visible red and a boundary located in the infrared region.

2. Anticollision light for aircrafts according to claim 1, characterized in that the average transmission factor in the first spectral domain is below 1%, preferably below 0.4%, and most desirably below 0.1% of its value in the second spectral domain.

3. Anticollision light for aircrafts according to claim 1, characterized in that the average transmission factor in the second spectral domain exceeds 80%, preferably 90%, and most desirably 95%.

4. Anticollision light for aircrafts according to claim 1, characterized in that the average transmission factor in the first spectral domain is less than 2−⁷ and that it sinks at least by a factor of 10⁴ between 600 nm and 700 nm.

5. Anticollision light for aircrafts according to claim 1, characterized in that the boundary lies between 640 nm and 700 nm, and preferably between 660 nm and 680 nm.

6. Anticollision light for aircrafts according to claim 1, characterized in that the first domain extends at least up to 850 nm, and preferably as far as 1000 nm into the infrared.

7. Anticollision light for aircrafts according to claim 1, characterized in that the second spectral domain extends at least over a visible white spectral domain, or at least over a visible red spectral domain.

8. Anticollision light for aircrafts according to claim 1, characterized in that it comprises a further filter (10) which attenuates wave lengths below the visible red light.

9. Anticollision light for aircrafts according to claim 8, characterized in that the further filter (10) is placed between the light source (6) of the anticollison light and the at least one optical filter (11).

10. Anticollision light for aircrafts according to claim 1, characterized in that the one filter (11) is an interference filter (11), and in particular that the further filter (10) is an absorption filter (10).

11. Anticollision light for aircrafts according to claim 10, characterized in that the interference filter (11) consists of several flat elements (11).

12. Anticollision light for aircrafts according to claim 1, characterized in that the one filter (11) is an interference band-pass filter with transmission band situated in the region of visible red light.

13. Anticollision light for aircrafts according to claim 10, characterized in that the band-pass filter consists of several flat elements.

14. Anticollision light for aircrafts according to claim 1, characterized in that it comprizes a flashing light source (6) in the shape of a fluorescent tube which winds torus-like over more than 200° around an axis (2), and is surrounded by a reflector (7, 7¹) which also extends in an essentially torus-like shape over more than 200° and exhibits a slit along its outer periphery, where the aperture of the slit, as seen from the circular longitudinal axis of the fluorescent tube (6) in a plane containing the axis, has a maximal aperture angle (α) of 180°, preferably of 130°, and most desirably of 90°.
